(19) United States
(12) Patent Application Publication
(10) Pub. No.: US 2010/0170748 A1
(43) Pub. Date: Jul. 8, 2010

(54) Telescoping ladder safety grab arms and accessories

(76) Inventor: Gary J. Robichaud, Scarborough (CA)

Correspondence Address: Gary J. Robichaud, Suite 1502, 250 Brenyon Way, Scarborough, ON, M1B-3G3, CA

(21) Appl. No.: 12/654,387

(22) Filed: Dec. 17, 2009

Related U.S. Application Data
(60) Provisional application No. 61/203,018, filed on Dec. 19, 2008.

(30) Foreign Application Priority Data
Feb. 13, 2007 (CA) 2,579,931

(51) Int. Cl. E06C 7/18

(52) U.S. Cl. 182/107

(57) ABSTRACT

This invention relates to an attachable ladder device either fastened or moveable for securing a ladder to a work area by means of interchangeable accessories designed to attach to a work station such as eaves-troughs, industrial joist, roof bases, fascia's and walls by means of an adjustable telescoping arm with a safety belt.

Whereby, when working off an unsecured extension ladder, the safety of the user is jeopardized, thus fastening this device along with the appropriate accessories to a ladder, to a work area, allows the user the security to work worry free.

The accessories referred to consist of a stabilizing arm, eaves-trough grab and lock, joist grab and lock, as well as, the flush mount plate, all of which fit into said telescoping grab arms.

The accessories are easily attached and removed from the swing arm by an accessory holder with two locking knobs.

Said ladder safety grab arms consists of a 360° rotational telescoping arm actuated by a bearing attached to a ladder block which is fastened to the ladder stile, with a pivot fork and safety belt, which are attached to the telescoping arm to allow a further 180° flexibility both vertical and horizontal.

In this invention clamps, knobs, safety belts and the swiveling telescoping arm are used to secure and embrace the ladder to a structure.

### FIELD OF THE INVENTION

This invention relates to a ladder safety fastening device with extendable telescoping arms for securing a ladder to such things as eves troughs, industrial joist, fascias and the stabilization of ladders for the mounting and dismounting off of a roof.

### BACKGROUND OF THE INVENTION

Ladders perform an invaluable function in the lives of everyday workers, homeowners, trades people and maintenance crews to name a few.

Insofar as there functionality goes, technology has given us both the designs and the materials needed to produce some of the strongest ladders available. Although rugged construction and design of ladders have improved over the years, safety has not, that is the primary goal of this device.

This invention relates to a ladder add-on which in particular focuses on the safety of the user.

### SUMMARY OF THE INVENTION

It is common in extension ladder usage to have someone hold the ladder at the base or tie the ladder off at some points to avoid incidents of ladder slip out.

Where-by resorting to this device, once fastened to a secure location prevents any chance of ladder slip out and provides fall protection as well.

### BRIEF DESCRIPTION OF THE DRAWINGS

FIG. 1 Shows a side view of the ladder safety grab arm along with the necessary components.

FIG. 2 Shows a side view of the Eves-trough Grab and Lock accessory.

FIG. 2a. Shows a view of the Eves-trough Grab and Lock and how it would perform in its function.

FIG. 3 Shows a side view of the Joist Grab and Lock accessory.

FIG. 3a. Shows a view of the Joist Grab and Lock and how it would perform its function.

FIG. 4 Shows a top view of the Stabilizing Bar accessory.

FIG. 4a. Shows a view of the Stabilizing Bar accessory and shows how it would be made to work.

FIG. 5 Shows a top view of the Surface Mount Plate accessory.

FIG. 5a. Shows a view of the Surface Mount Plate and how it would be made to work.

FIG. 6 Shows a top view of the Alternative Ladder Block and its components.

FIG. 7 Shows a side and top view of the Ladder Clip on Holder.

The components of this device is made up of two telescoping arms working off of a ladder block, which consist of a ladder stile clamp either mounted or moveable, telescoping extendable arms, ball or thrust bearings, eyelet, or arm ring connections, ladder arm clamping knobs, safety belt and accessories.

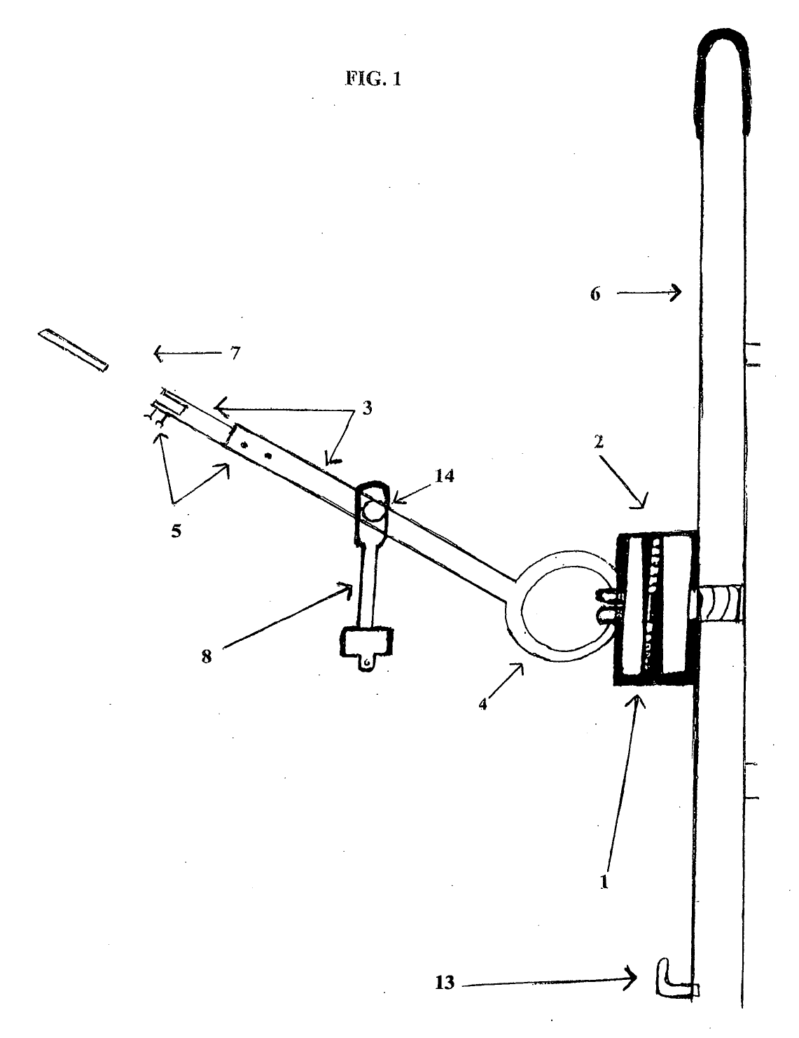

FIGS. 1, 2, 3, 7, represent a side view of the drawings.

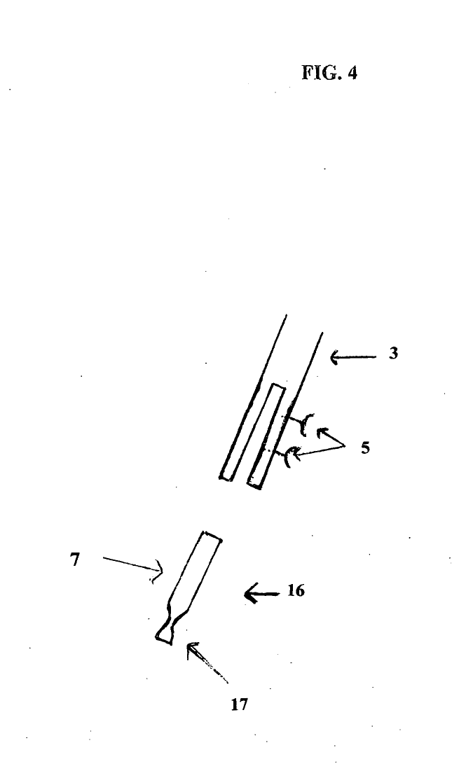

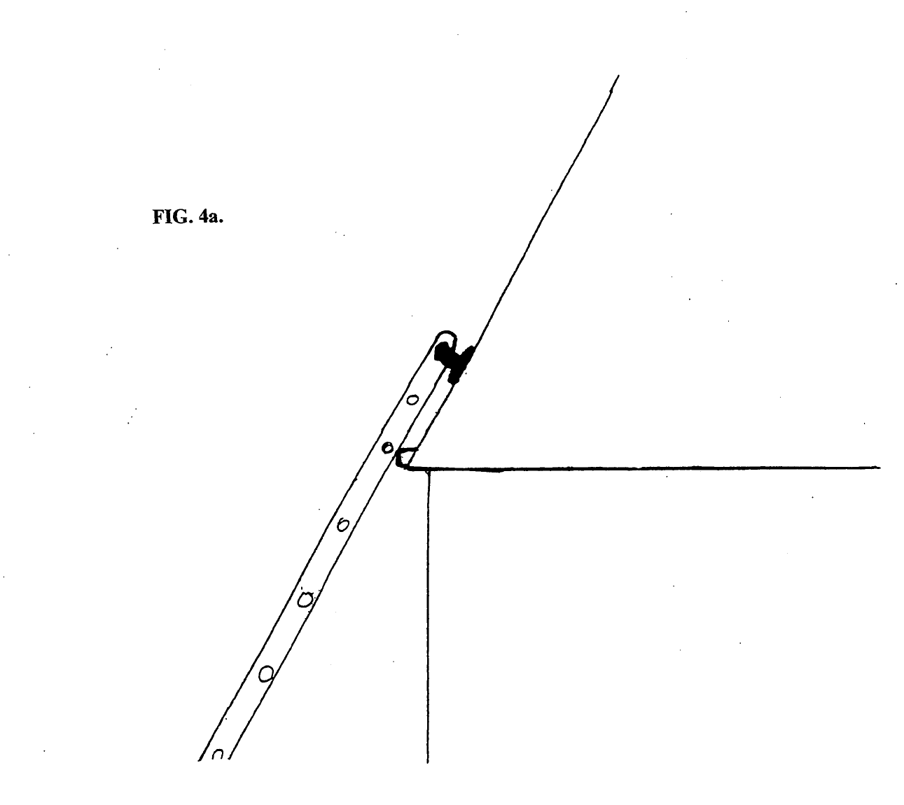

FIGS. 4, 5, 6, 7, represent a top view of the drawings.

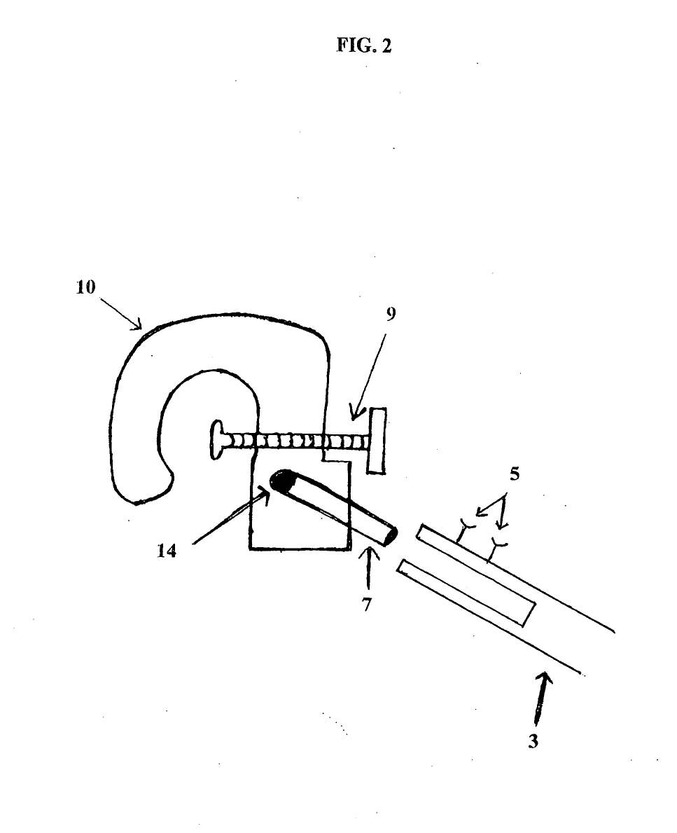

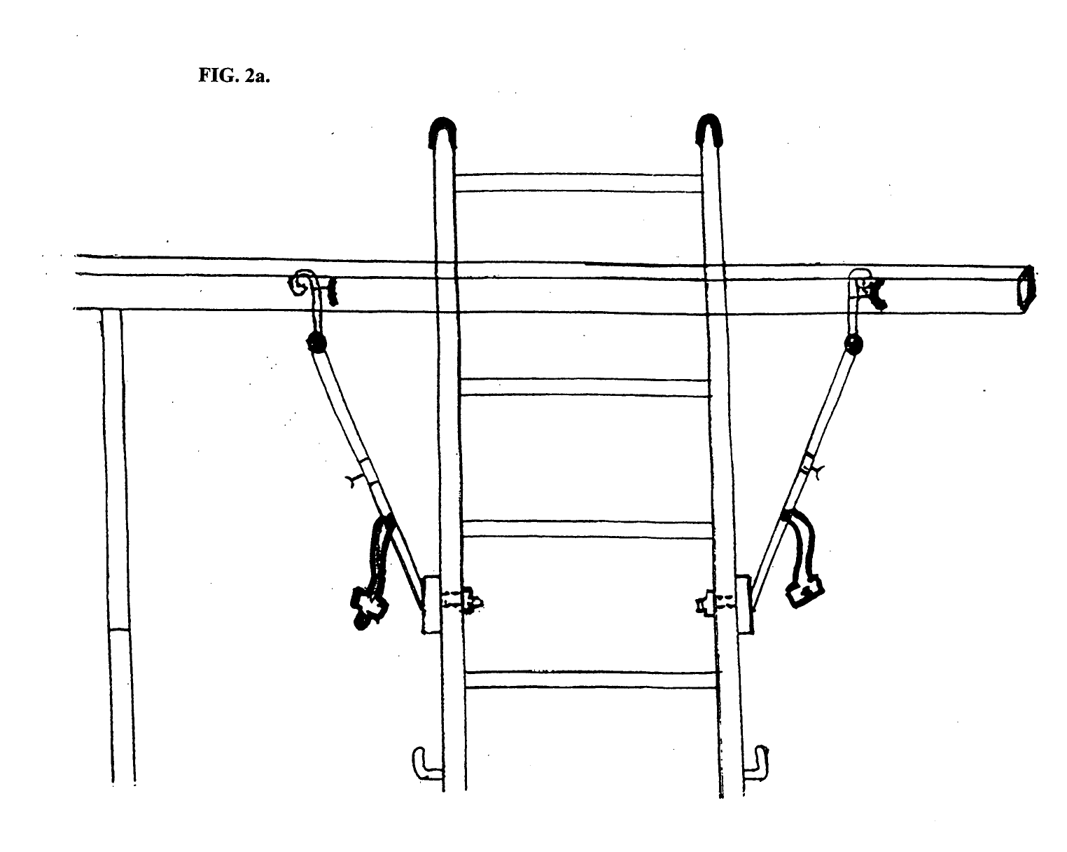

FIGS. 2a. -3a. -4a. -5a. depicts some of the many usages a user may have.

Ladder Grab Arm Legend

| | | | |
|---|---|---|---|
| Ladder Block | (1) | Bearing | (2) |
| Ladder Grab Arm | (3) | Arm Ring or Eyelet | (4) |
| Locking Knobs | (5) | Ladder Stile | (6) |
| Accessory Rods | (7) | Safety Belt | (8) |
| Clamping Knob | (9) | Eaves-trough G&L | (10) |
| Joist Grab and Lock | (11) | Flush Mount Plate | (12) |
| Clip On Holder | (13) | Pivot Pin | (14) |
| Shoulder Bolt | (15) | Stabilizing Accessory | (16) |
| Rubber Foot | (17) | Screw Access Holes | (18) |

### DETAILED DESCRIPTION OF THE PREFERRED EMBODIMENTS

FIG. 1 Shows a side view of the ladder grab arm and its components consisting of a ladder block (1) which when mounted to the ladder stile (6), affixes itself to the ladder. With the ladder block fastened to the ladder stile a thrust or ball bearing (2) located inside the ladder block now allows for a 360° circular rotation of the ladder grab arm (3). Also shown are the ladder block and bearing locations.

A metal tube and rod form the telescoping arm (3) with the rod being housed within the tube and having a telescoping arm ring (4) for mating with the other arm ring which is attached to the ladder block (1) to allow for a further 180° vertical up and down movement of the telescoping arms.

Number (5) are the locking knobs used to lock the accessory rods into the telescoping arm holder and as a lock for the telescoping grab arm after adjustment.

Number (8) represents a safety belt fastened on a pivot pin (14) which is attached to the ladder grab arm with a male and female locking clasp to allow for mating with the user belt, whereby, when engaged with the safety belt worn by the user with the opposite mate, form a locked and secure fastening system to prevent any chance of a user falling off of the ladder.

Number (13) relates to the clip on grab arm holder, which clips on to the ladder stile. When needed the clip on is used to secure the ladder grab arms along side of the ladder stile while the grab arms are not in use or in a resting position.

FIG. 2 Shows a side view and relates to the eaves-trough grab and lock accessory (10) which embraces and fastens to the lip of the eaves-trough, and when combined with the clamping knob (9) securely affixes itself to the eaves-trough. Number (7) relates to the interchangeable accessory rod for fastening to the grab arms (3).

Number (14) relates to a pivot pin to allow for more adjustment of the grab and lock accessory. Number (5) relates to the locking knobs, used for locking the accessory rod (7) into the grab arm accessory holder (3).

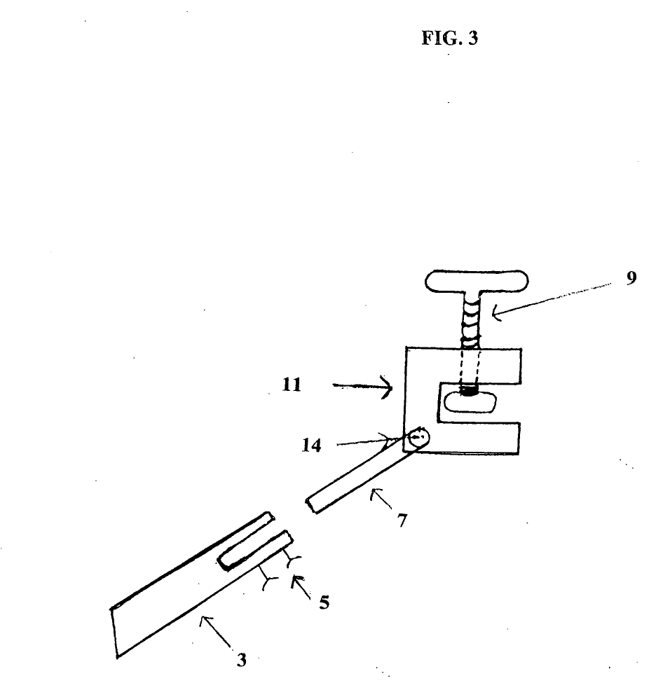

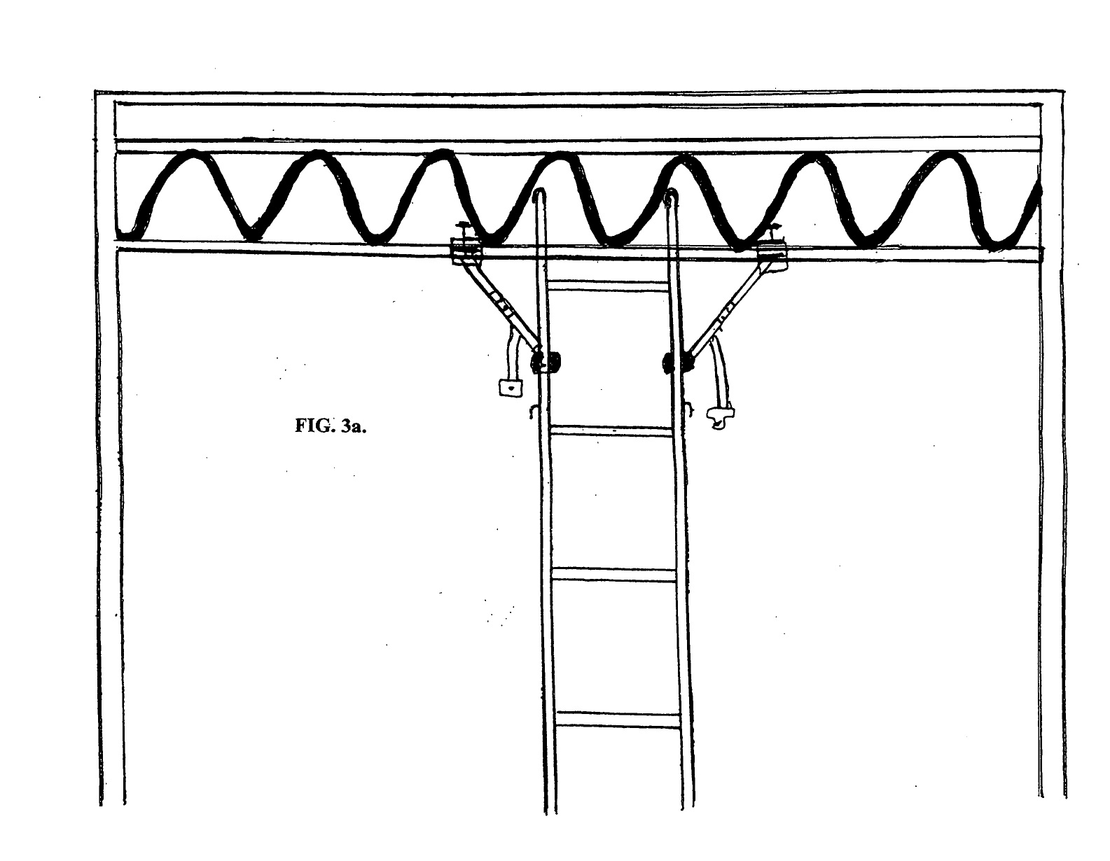

FIG. 3 Shows a side view of the joist grab and lock accessory (11), along with the interchangeable accessory rod (7), the ladder grab arm (3), clamping knob (9), locking knobs (5) and pivot pin (14), all working together to fasten the ladder to such structures as industrial joist as illustrated in FIG. 3a.

FIG. 4 Shows a top view of and relates to the stabilizer attachment (16) and accessory rod (7) used mainly for the stabilizing of the ladder when mounting and dismounting off of such things as a roof and consists of the accessory rod (7) with rubber feet.

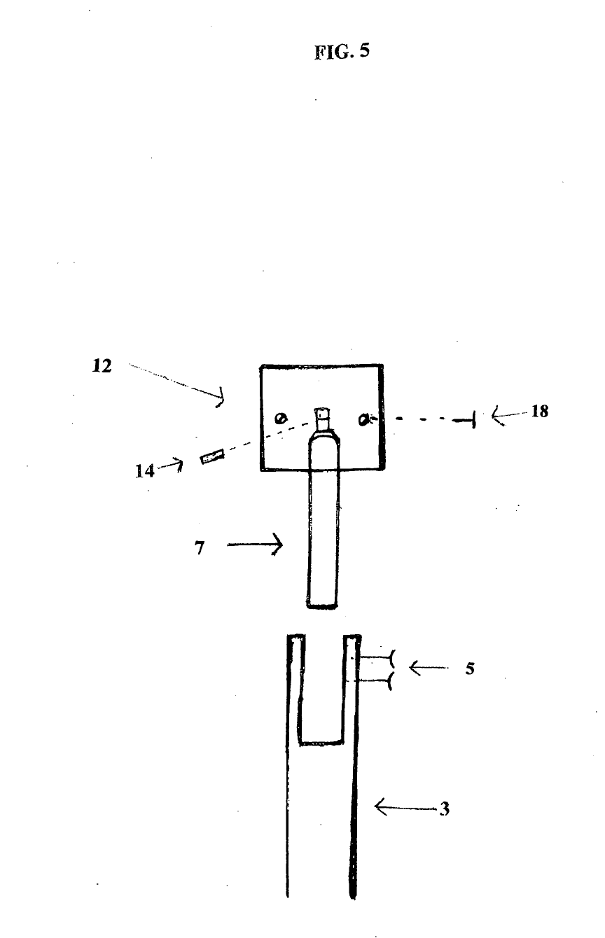

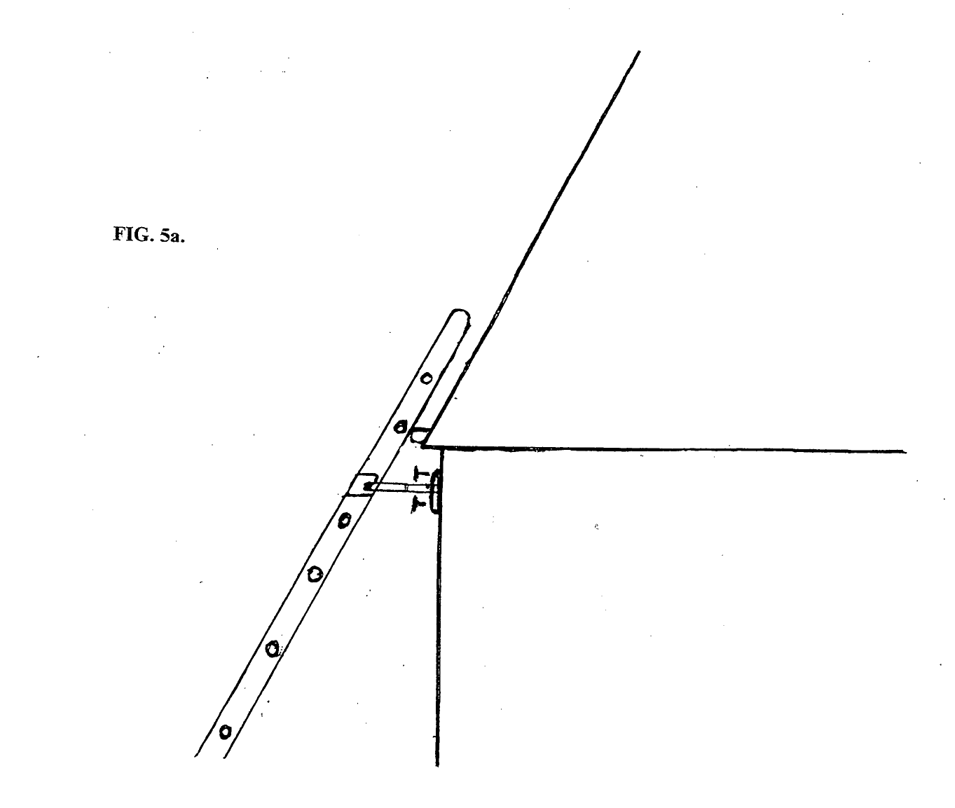

FIG. 5 Shows a top view and relates to the surface mount plate (12) and accessory rod (7) along with two pre drilled screw access holes (18) to allow for screws to be inserted and to allow for the fastening of the ladder to such things as fascias, brick walls, etc. Number (14) relates to the pivot pin which allows for adjustment of the different slopes or angles on which the ladder may be leaning. Numbers 3 and 5 represent the ladder grab arm and locking knobs.

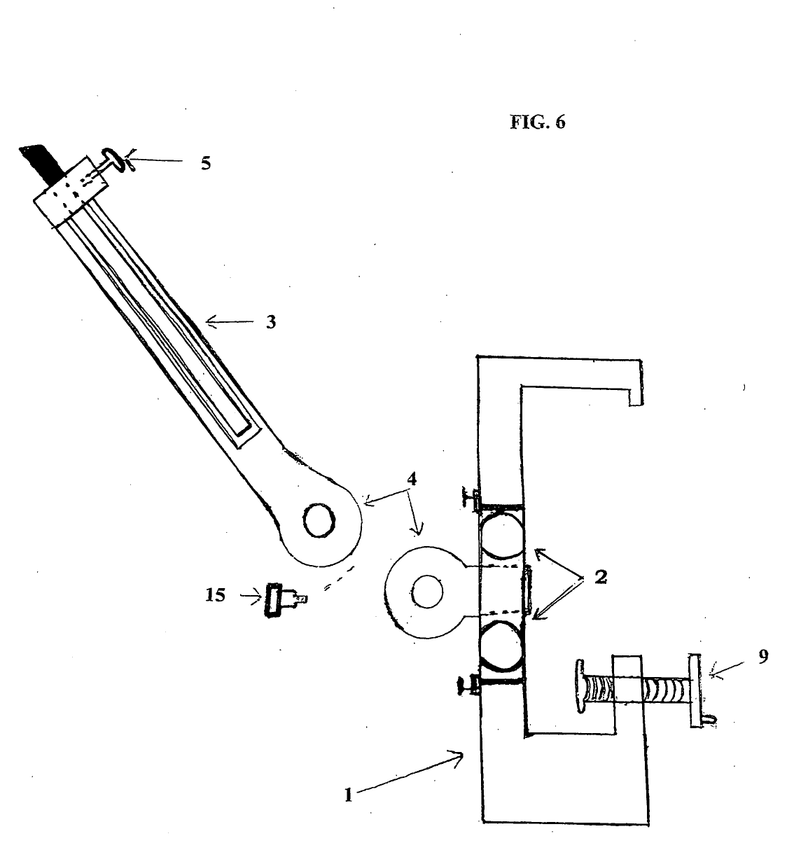

FIG. 6 Shows a top view of the movable alternative ladder block. The purpose of this attachment is, instead of having a fixed attachment where-by you jeopardize the integrity of the ladder by drilling holes into the ladder, with this alternative you now have the ability to slide the ladder block any where up or down on the ladder stile without any damage to the ladder.

FIG. 6 Shows a top view of and relates to the components of the alternative ladder block.

(1) shows the moveable universal block that can adapt to just about all ladder styles whether it be, inward or outward lip or full ladder stile.

(2) Relates to the recessed roller ball or thrust bearing located inside the ladder block.

(3) Relates to the telescoping arm with an eyelet connection.

(4) Relates to the eyelet connection, one being part of the telescoping arm (3) and one being part of the ladder block (1) which is fastened to the ladder stile.

(9) Relates to the locking clamp knob which is used for securing the ladder block to the ladder stile.

(5) Relates to a locking knob (5) as being part of the grab arm.

(15) Relates to a shoulder bolt used to connect together the eyelet connections for the vertical up and down movement of the grab arms.

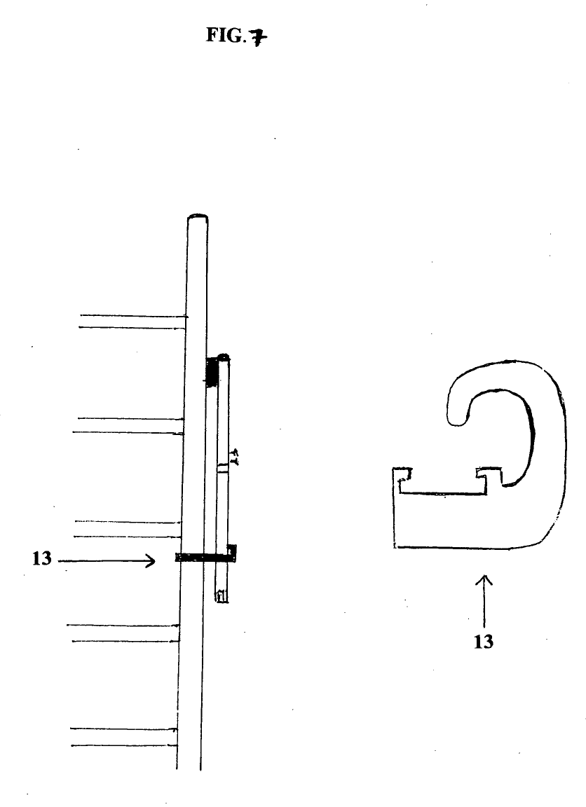

FIG. 7 Relates to the clip-on grab arm holder used for securing the ladder grab arms along side of the ladder when not in use or in resting position.

1. A ladder fastening safety device comprised of a pair of telescoping arms, with each one affixed at one end to the ladder by means of the alternative ladder block, and with the other telescoping end indented or recessed for receiving and accepting the accessory rods.
Telescoping arms consisting of two sections, one being tubular and one being a solid rod with a formed end for receiving the accessory rods. The tubular section is formed at such dimensions as to accept the rod section to within its housing, allowing the grab arm the ability to perform the telescoping action. The tubular section of the grab arm is also formed with an eyelet or arm ring connection for mating with the ladder block.
Alternative ladder block, consisting of a wrap around or fasten able ladder block formed to fit along side the ladder stile and clamped into place by means of the clamping knob or bolt. Ladder block also having a ball or thrust bearing located within the ladder block and having a connecting ring or eyelet press fitted to within the bearing for allowing for a 360° rotational movement of the ladder grab arms.
Eyelet or arm ring connector protrudes outward from the ladder block for connection between the ladder grab arm and the ladder block, also enabling the grab arm the additional flexibility of a 180° up and down movement of the ladder grab arms.

2) Dependent of the ladder grab arm and ladder block are the accessories as is described in the specifications and drawings. The accessories speak for themselves in which they are described and shown in the drawings and consist of a:
a) Eves-trough Grab and Lock Accessory
b) Joist Grab and Lock Accessory
c) Flush Mount Plate Accessory
d) Stabilizing Arm Accessory

3) The safety belt and clip on holder although not an essential feature plays an important role in the safety and convenience of the user and warrants a claim.
The safety belt having one male and female clasp and affixed to the ladder grab arm, when married with the safety belt worn by the user gives the user the ultimate in fall protection.
Two clip on tension holders allows for the ladder grab arms to be securely fastened along side the ladder stiles when not in use or at rest.
